(19) United States
(12) Patent Application Publication
(10) Pub. No.: US 2016/0337351 A1
(43) Pub. Date: Nov. 17, 2016

(54) AUTHENTICATION SYSTEM

(71) Applicant: ACUITY SYSTEMS, INC., Visalia, CA (US)

(72) Inventors: Herbert W. Spencer, Grass Valley, CA (US); Christopher M. Canfield, Santa Clarita, CA (US); Vincent Conroy, Novato, CA (US); Todd Hickerson, Colorado Springs, CO (US)

(21) Appl. No.: 15/111,778

(22) PCT Filed: Jan. 14, 2015
(86) PCT No.: PCT/US15/11330

§ 371 Date: Jul. 14, 2016

Related U.S. Application Data
(60) Provisional application No. 61/927,936, filed on Jan. 15, 2014.

(51) Int. Cl. H04L 29/06

(52) U.S. Cl. CPC H04L 63/0876; H04L 63/102; H04L 63/083; H04L 63/0861

(57) ABSTRACT

A system and method for authenticating one or more devices to access a secure resource utilizing device trait characteristics and user identification. Embodiments of the present invention include a multiple device authentication system (100), a direct mode authentication system using an access code (200), a direct mode authorization system (300), a direct mode authentication binding using tap to login (500), direct mode authentication binding system—single device login (600), direct mode login after binding (700), and single device login using a web browser or access application (800). Example disclosed embodiments include: obtaining user information about a user of a hardware device, authenticating the user from the user information, obtaining a hardware profile of the device, where the hardware profile includes user generated data stored on the device, and linking the user information and the hardware profile as a combined electronic identification.

### CROSS-REFERENCE TO RELATED APPLICATIONS

The present Application is a national stage application of International Patent Application PCT/US2015/011330 filed, Jan. 15, 2015. International Patent Application PCT/US2015/011330 claims the benefit application claims the benefit under 35 U.S.C. §119(e), to U.S. Provisional Application U.S. 61/927,936, filed Jan. 15, 2014, entitled “AUTHENTICATION SYSTEM” which is incorporated by reference in its entirety and made part of this specification. This application is related to U.S. Provisional Patent Application No. 61/612,023 filed Mar. 16, 2012, 61/708,607 filed Oct. 1, 2012 and 61/737,577 filed Dec. 14, 2012; PCT Application No. PCT/US2013/32040 filed Mar. 15, 2013 (attorney docket 50062-3PCT); PCT Application No. PCT/US2013/061245 filed Sep. 23, 2013 (attorney docket 50062-4PCT); U.S. Provisional Patent Application No. 61/763,401 filed Feb. 11, 2013; U.S. Provisional Patent Application No. 61/789,956 filed Mar. 15, 2013; U.S. Provisional Patent Application No. 61/803,319 filed Mar. 19, 2013; and U.S. Provisional Patent Application No. 61/821,176 filed May 8, 2013. All of these applications are incorporated herein by this reference.

### BACKGROUND

Identity fraud is the leading type of credit card fraud in the US. Over nine million adults are victims each year, which results in $100 million in merchant losses. Despite the increased digital power at our disposal, the state of the current security systems available for the prevention of identity fraud is still inadequate. A problem associated with current security systems is that they lack the ability to truly discern an identity of an individual at the fundamental level. Accordingly, there is a need for a better security system that is able to truly discern an individual's identity in order to prevent identity fraud.

### SUMMARY

The present invention is directed to methods and systems that satisfy this need to prevent identity fraud. An exemplary method described herein comprises steps of obtaining user information about a user of a hardware device, authenticating the user from the user information, obtaining a hardware profile of the device, the hardware profile comprising user generated data stored on the device, and linking the user information and the hardware profile as a combined electronic identification. The hardware device can comprise a processor, memory, a touchscreen interface, and a wireless communication module, and can be a device such as a mobile phone, computer, or tablet computer. Aspects of the present invention are directed to utilizing more than one device to provide user access to a secure resource.

### DRAWINGS

FIG. 1 depicts a system for authenticating multiple devices;

FIG. 2 depicts a direct mode authentication binding using access code;

FIG. 3 is a device screen shot depicting a direct mode access button;

FIG. 4 is a device screen shot depicting an exemplar list of resources;

FIG. 5 depicts a direct mode authentication system binding using tap to login;

FIG. 6 depicts a direct mode authentication binding using single device login;

FIG. 7 depicts direct mode login after binding;

FIG. 8 depicts single device login using web browser or access application;

FIG. 9 is a device screen shot depicting an exemplar website set up for a second factor authentication;

FIG. 10 is a device screen shot depicting an exemplar authentication server's website;

FIG. 11 is a device screen shot depicting an authentication application;

FIG. 12 is a device screen shot depicting access granted to a resource on a device.

FIG. 13 depicts an automatic redirect to authentication server during login.

### DESCRIPTION

This invention is directed to increasing security for access to a secure resource by making sure that not only the user is authorized to access the resource, but in addition, ensuring that the user is using an authenticated device for access, or a device that has been vetted by an authenticated device. Methods of this invention describe an additional layer of security as compared to security relying only on a user name and password. So even if there is a password available, there is no access to a secure resource until an authentication server confirms an authenticated device is being used or has been vetted by an authenticated device.

Authentication can utilize an authentication application on a device such as a smart phone in combination with an authentication server. The server has access to information about registered devices and can be used to authenticate that a particular device in communication with it is a particular registered device and authenticate it. The device to be authenticated can have an authentication program that initiates communication with the authentication server. A preferred version of an authentication protocol is known as TRAITWARE™ and is described in PCT application serial numbers PCT/US2013/032040 (Publication No: WO2013138714 A1) and PCT/US2013/061245 (Publication No: WO2014055279 A1). Where reference is made herein to TRAITWARE™ any suitable authorization program and server can be utilized.

The drawings and the following description refer to a “server.” The term “server” refers to a system that responds to a request across a computer network to provide or help to provide a network service. The server can run on a dedicated computer. A server as specified by this application can be provided by one or more than one computer type device.

The reference to a device or hardware device is any device configured such that the device has the ability to engage in communication with a communication network (such as the internet), and includes devices such as cellular, satellite, and other forms of internet connectivity. The device can be capable of capturing biometric input including, but not limited to, fingerprint, facial recognition, voice verification, and vein verification. The device typically comprise a processor, memory, input interface transmitter, and touch screen, the processor being programmed to process, through the input interface, user information, transmit through the transmitter user information to a server, and receive input from a server. In one embodiment of the invention, the device is a mobile phone, computer, or tablet computer. The interface preferably is a touch screen interface, and preferably the transmitter is a wireless communication module.

### Multiple Device Authentication System

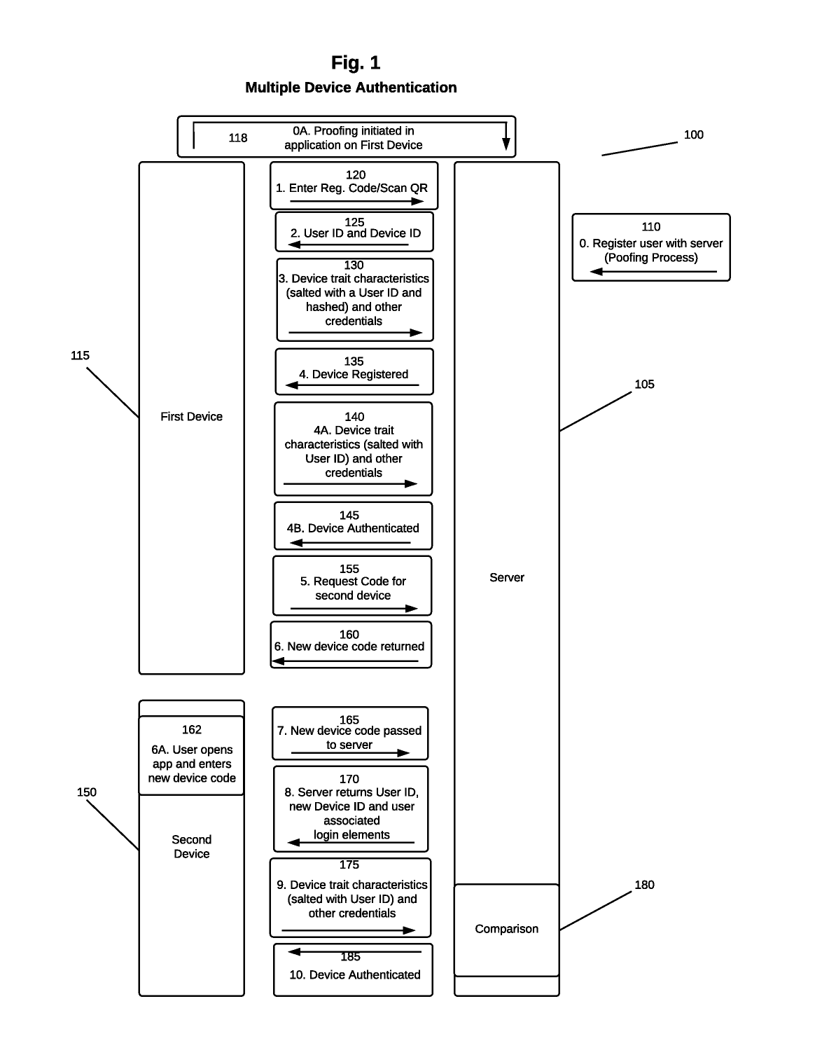

Turning now to FIG. 1, multiple device authentication 100 and the steps numerated therein, after a person has been successfully identity proofed on a first device they should easily be able to pass that identity to another device in a secure manner. The process described herein allows someone with an authenticated first device to pass a credential to a second device—allowing the second device to be authenticated and linked to the user associated with the first device. A device is authenticated when it is confirmed that it is the actual device that was previously registered. Device authentication differs from authorization—authorization being the function of specifying access rights to resources. In a preferred method, a second device can be authenticated based on a percentage of a matching hardware profile in relation to the first device, where the hardware profiles of the first and second devices are compared against each other. Alternatively, the second device can be authorized by simply receiving a credential from the first device. The credential can be a one-time generated code in a numeric or visual form such as a matrix code, also known as a quick response code (QR codes). The code can be transmitted from the first device to the second device by manual entry, a QR scan, Bluetooth communication, NFC (near field communication), or other communication methods known in the art.

Turning again to FIG. 1, Step 0. A user registers in a proofing process 110 with a server 105 and is assigned a unique User ID, also referred to as a user identification code, by the server. The user's identity is proofed, i.e. confirmed. This can be before or after a particular first device 115 is registered by the user in step 4. Proofing 110 can be done as usual in the art such as asking questions (e.g. date of birth, mother's maiden name, where a significant other was met, e-mail address). Proofing 110 can be performed on a first device, on a server or elsewhere, such as in front of a governmental authority with access to a biometric database. If proofing happens separate from first device 115, preferably a registration code or similar code is used to associate first device 115 with the proofed individual whose User ID is stored on the server. The proofing authority may be the owner/administrator of the server or a third party. If the proofing authority is a third party, the third party communicates the results of the proofing to the server, which would then create a unique User ID associated with that user. If proofing 110 occurs on the first device the proofing authority can send a credential to the first device indicating that the user has been successfully proofed. Alternatively, proofing can be initiated on the first device from within the TRAITWARE™ application. Proofing 118 is initiated on first device 115, wherein a user can register themselves on the first device 115 by using the TRAITWARE™ application.

Step 1. In the preferred method the user enters 120 the registration code on the first device for transmission to server 105. The user may scan a QR code containing the registration code or receive the registration code through other communication protocols known in the art, such as Bluetooth and NEC. If the user was proofed on first device 115 and has received a credential on first device 115 indicating a successful proofing, this credential can be passed, acting as a registration code, to server 105.

Step 2. If the user is proofed, the user is assigned a unique User ID and a unique device ID for first device 115. If proofing happens separate from first device 115, a registration code or similar device ID is used to associate first device 115 with the proofed individual. For example, a registration code can be provided by a proofing authority and entered into a registration screen of first device 115 to create an initial association. The first device is sent 125 a User ID and a Device ID by server 105. A User ID may be associated with a number of Device IDs (one-to-many) while a Device ID is specific to a particular device (one-to-one).

Step 3—This step begins the process to register and authenticate the first device. Device trait characteristics are collected and sent 130 from first device 115. “Device trait characteristics” include the “hardware profile” described in aforementioned PCT Application PCT/US2013/032040, (Publication No: WO2013138714 A1), and also include device provided identification information such as serial number, processor number, and device type. Preferably the User ID is used to salt the device trait characteristics by adding data to the device trait characteristics, before they are hashed. Salting optionally can be performed with other user credentials alone or in combination with the User ID. The credential can be a password, pin, biometric information, and/or image code information such as a PHOTOAUTH™ key (described below). Salting with the User ID instead of the Device ID makes it possible to salt the device trait characteristics on a second device with the same User ID, but allow for a separate Device ID.

Since device trait characteristics from separate devices are salted with the same User ID, it is possible to compare device trait characteristics from separate devices to look for similarity. Additional credentials can be required to be passed to the server, such as a password, PIN, image code information. “Image code information” is data relating to a user being authorized by selecting certain images. An example of this is a PHOTOAUTH™ key which is image data taken from a sequence of images selected by the user and transformed into a unique string. These additional credentials can also be used in combination with the User ID to salt the device trait characteristics.

Step 4—The first device 115 is now registered 135.

Step 4A The user is given the ability to authenticate first device 115, The device trait characteristics are collected and sent 140 to server 105 and compared against those collected in sent 130 in step 3 during registration. Authentication is an optional step because the registration can also serve as the first authentication. Authentication can be effected by an authentication application, and preferably with a TRAITWARE™ application on the first device 115. The TRAITWARE™ application gathers device trait characteristics and user information (PIN, biometric, PHOTOAUTH™ key), salts and hashes the gathered characteristics and information, and transmits this to server 105 capable of comparing the salted and hashed characteristics and information and comparing them against stored information. An example server 105 is a TRAITWARE™ server that stores the authentication and authorization components of the process. It receives and holds the device trait characteristics used for authentication. It also holds a list of available client applications used in this process and any associated user/device authorization credentials for those applications. It also holds the client application's client identification and secret keys used in the OAuth process described below.

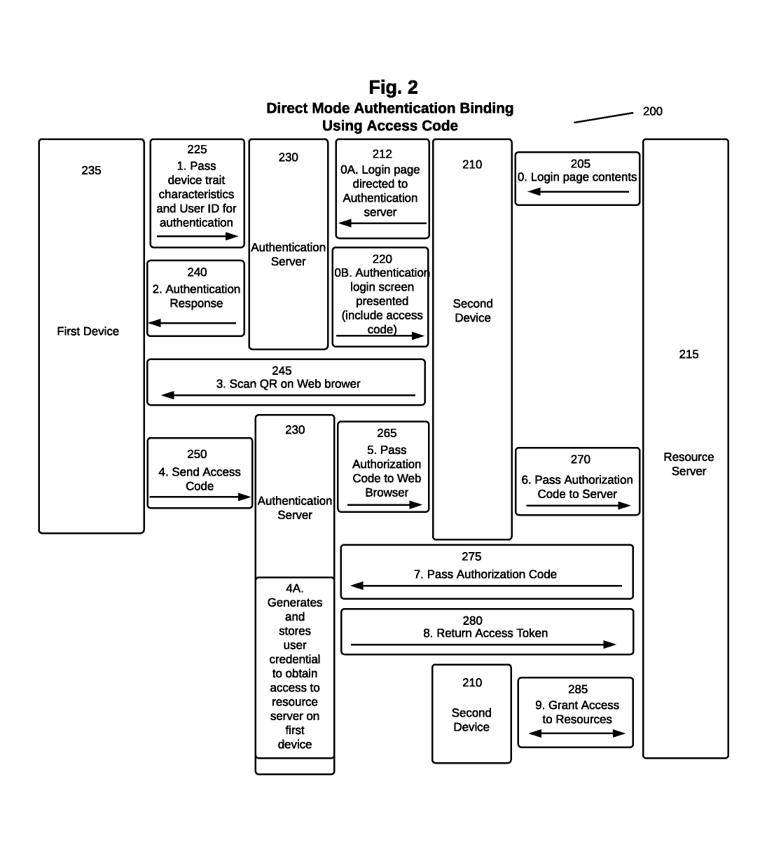

The TRAITWARE™ application is described in detail in the aforementioned PCT Application No. PCT/US2013/032040 filed Mar. 15, 2013, (Publication No: WO2013138714 A1), with reference to FIG. 2A (see block 200 for the TRAITWARE™ application and server 212 that can serve as the TRAITWARE™ server).

Thus in Step 4A device trait characteristics such as a hardware profile are collected from first device 115. Preferably the User ID is used to salt the device trait characteristics which are then hashed. Salting optionally can be performed with user information alone, or the User ID in combination with user information. “User information” is described in aforementioned PCT Application PCT/US2013/032040 (Publication No: WO2013138714 A1). Salting with the User ID and/or user information instead of the Device ID makes it possible to salt the hardware profile elements on a second device while allowing for different Device IDs for each device. Since hardware profiles from separate devices are salted with the same User ID and/or under information it is possible to compare hardware profiles from separate devices to look for similarity. Additional credentials can be required to be passed to server 105, such as a password, PIN or PHOTOAUTH™ key for additional authentication. These additional credentials may also be used in combination with a User ID and/or user information to salt the hardware profile.

Step 4B—The first device 115 is authenticated 145 and the user is given the ability to request the addition of a second device 150.

Step 5—When the user wants to add the second device 150 (without having to go through the proofing process again), the user requests 155 a new device code with the first device 115. This code can be provided via a one-time password (OTP) or a QR code. The code could be requested from a button located in a settings page within a TRAITWARE™ application on the first device 115 where first device 115 queries the server 105 for a new device code.

Step 6—A new device code is returned 160 to first device 115.

In Step 6A, the second device 150 user opens a second device authentication application, such as, in one embodiment, a TRAITWARE™ application (the TRAITWARE™ application can be stand alone on a server or embedded in an application). The application displays a registration prompt on the second device, and the user enters 162 the new code on the second device such as inputting the OTP or scanning the QR from first device 115 into second device 150. In Step 7, second device 150 passes 165 this code to server 105.

Step 8—Server 105 returns 170 the User ID associated with that OTP/QR, a new Device ID and other login associated elements to second device 150. The other login-associated elements could be a PHOTOAUTH™ image array, a biometric hash, a biometric feature set, a full biometric representation, a password requirement, a PIN hash, or a PIN sequence.

Optionally, the user can be required to provide one or more of the following elements on the second device to be sent to the server for additional authentication: a PHOTOAUTH™ image sequence, a biometric identifier, a password or PIN, and/or a unique identifier. The second device can also use the User ID, a PHOTOAUTH™ Hash, or any combination of available elements to salt the hardware profile on the second device. The PHOTOAUTH™ hash is a hash of concatenated image data from user individually selected images from a PHOTOAUTH™ sequence of images. The PHOTOAUTH™ sequence is the images chosen, in a specific order by a user, to unlock the TRAITWARE™ application.

Step 9—The second device 150 trait characteristics are sent 175 from second device 150 to server 105 for comparison 180 against the trait characteristics from one or more devices previously registered by the user, such as first device 115. If comparison 180 is within system specified tolerances, second device 150 is authenticated 185 and the new Device ID is associated with the User ID. If the comparison is not within allowed tolerances, the Device ID is discarded from server 105 and second device 150 is not authenticated or associated with the User ID. For example, a user with an IPHONE® as a first device and an IPAD® as a second device is expected to have very similar hardware profiles because such data as contacts and music are commonly the same across platforms. The allowed tolerance is dependent on the level of security required, and can be as high as 99% matching or as low as 10% matching, or even lower.

Thus using first device 115 as initial proof of identity we have now authenticated second device 150 when the trait characteristics comparisons 180 of the first 115 and second 150 devices are within allowed tolerances.

It is also a feature of the present invention that the difference in trait characteristics from one device to another upon registering a new device can be used to determine whether a transaction may proceed or not. The business rules of the system can dictate the outcome of an authentication attempt or a level of assurance of an identity on a new device.

Thus embodiments of the invention disclose a method for a user having a first device to authorize a second device comprising the acts of: a) accessing a first server with the first device; b) requesting with the first device authorization for the second device from the first server; c) receiving an authorization code from the first server on the first device; d) transmitting the authorization code from the first device to the second device; e) transmitting the authorization code to a second server with the second device so that the second server can authenticate the second device; and f) receiving a notice that the second device has been authenticated. In one embodiment, the first and second servers are the same server. In another embodiment, the first device is authorized. In another embodiment, the inventive method comprises the additional acts of: a) transmitting a first device's trait characteristics from the first device to one of the servers; and b) transmitting a second device's trait characteristics from the second device to one of the servers for comparison of the hardware profiles so that the second server can authenticate the second device. Additionally, the inventive method teaches a user having an identification code and the act of transmitting the first device trait characteristics includes salting the first device trait characteristics with the user identification code and/or user information, and the act of transmitting a second device trait characteristics includes salting the second device trait characteristics with the user identification code and/or user information. Importantly, in one embodiment the salting of first device and second device are independent. In another embodiment, the salting of first device and second device is the same. In one embodiment, the salting is with the user identification code in combination with a password, PIN, user biometric information, or image code information. In another embodiment, no salting of either the first or second device hardware profiles occurs. Additionally, whether salted or unsalted, the hardware profile may be truncated to prevent disclosure of personal information. Further, in one embodiment, the present invention discloses a computer implemented system for authorizing a second device for a user having a first authorized device comprising the acts of: (a) receiving a request from the first device for an authorization code for the second device; (b) transmitting the authorization code to the first device; (c) receiving the authorization code from the second device; (d) authenticating the second device; and (e) transmitting a notice that the second device has been authenticated. In one embodiment this system includes a computer or memory device having a program for performing the method described in steps (a)-(e).

### Direct Mode Authentication Binding Using Access Code

The system of FIG. 1 is useful for authenticating a second device owned by a user where a second device has a hardware profile similar to the hardware profile of a first device. This routinely occurs is a single user owns such devices as an IPHONE® and an IPAD®. But this system does not work if a second device does not have a similar profile, such as the case of public computers found at hotels, or public internet facilities, or where a borrowed device is the second device. In such cases, an alternative system will allow a second device to access a secure resource. This system also allows a first device to access the secure resource. The following is an embodiment of this invention illustrated by FIG. 2 wherein a secure resource website login page is displayed on a web browser of a second device that initially lacks authorized access to the secure resource. A secure resource is a web site or application that requires authorization to access, i.e. is not available to the general public. The secure resource is hosted on a resource server.

Turning now to FIG. 2, demonstrating an embodiment direct mode authentication binding using an access code 200. Step 0—A login page for the secure resource is presented 205 to a second device 210 via a web browser on the second device 210. One option on the login page is to select an authentication server to achieve access to the secure resource.

Step 0A—If the user selects the authentication server, the resource login page is automatically redirected 212 to the authentication server 230. In a preferred embodiment, using a TRAITWARE™ authentication server, a user may click on a “login with TRAITWARE™” button, and the login page is directed 212 to authentication server 230.

Step 0B—The authentication server automatically presents 220 a login page, such as a TRAITWARE™ login page, to the web browser on the second device 210. The login page can contain an access code such as a QR code and a field to enter a credential.

Steps 0A and 0B can happen instantly without the notice of the user, appearing as if the initially rendered page was originating from resource server 215, when it is actually coming from authentication server 230. In another example, the portion of the page from authentication server 230 can also be embedded in a page from resource server 215.

Step 1—The first device 235, which has been authorized, passes 225 authorization credentials, including device trait characteristics and a user identification, to the authentication server 230 for authentication. The user identification can be those conventionally used such as an e-mail address, user name, pin number, password, user information, or biometric.

Step 2—If authentication is successful, first device 235 receives 240 a successful authentication response. The user is allowed to use the functionality of the TRAITWARE™ application on first device 235.

Steps 1 and 2 can be performed before step 0, 0A, and 0B. Steps 1 and 2 only need to be performed before step 4.

Step 3—Using first device 235, the user acquires the access code 245, such as by scanning or taking a picture of a QR code, presented on the website on second device 210. Because the access code is generated by authentication server 230 upon a request from resource server 215, the access code is associated with the particular resource or resources accessible through or on resource server 215.

Step 4—First device 235 sends the scanned access code 250, such as a QR credential, to authentication server 230. Upon receipt of the access code, authentication server 230 associates the User ID or Device ID from first device 235 with the resource server 215 hosting the server application that initially requested the QR code. Device ID is a unique string that is created by authentication server 230 when the user registers a device with authentication server 230. It is assigned to the user's authentication server account and passed to the registered device. The User ID here refers to a unique string that is created by authentication server 230 and associated with a user account when a user account is created in authentication server 230. This association acts as a secure resource authorization code or credential for subsequent login attempts to the secure resource.

Step 4A—This system can also be used to gain access to the resource for first device 235. Upon receipt of the access code from the authenticated first device, first device 235, having been authenticated, can now provide access to the secure resource for future direct access. Optionally only after the following steps 5-8 are performed does first device 235, whenever authenticated, have direct access to the secure resource on resource server 215. This is a single device mode where first device 235 is being used for authentication, and, once authenticated, can then provide access to and display content from resource server 215 on first device 235.

Step 5—Authentication server 230 communicates or passes 265 a redirect URI and the authorization code to website browser on second device 210.

Step 6—Website browser on second device 210 uses the redirect URI and an authorization code and passes 270 them to the resource server 215.

Steps 7 and 8—Authorization code is passed 275 from resource server 215 to authentication server 230. Then, authentication server 230 returns 280 an access token to resource server 215. In this way, resource server 215 exchanges an authorization code for an access token. Access tokens are credentials used to access protected resources.

Finally, in Step 9—resource server 215 grants 285 second device 210 access to the secure resource (the web browser) on the second device 210.

An access token is a string representing an authorization issued to the client. The string is usually opaque to the client. Tokens represent specific scopes and durations of access, granted by the resource owner, and enforced by a resource server and an authorization server. Here, as illustrated, the resource server is also the authorization server, but in an alternative embodiment, the resource server and authorization server are distinct. The token can denote an identifier used to retrieve the authorization information or can self-contain the authorization information in a verifiable manner (e.g., a token string consisting of some data and a signature). Additional authentication credentials, can be required in order for the client to use a token. The access token provides an abstraction layer, replacing different authorization constructs (e.g., username and password) with a single token understood by a resource server. This abstraction enables issuing access tokens more restrictive than the authorization grant used to obtain them, as well as removing a resource server's need to understand a wide range of authentication methods.

Access tokens can have different formats, structures, and methods of utilization (e.g., cryptographic properties) based on a resource server's security requirements.

This process can be used to provide access to multiple secure resources in addition to the resource that provides the initial login page in step 0.

The above processes and methods can include passing some credentials to a resource server for authentication (in Step 1) prior to authenticating a device via an authentication server. Initially authenticating with a resource server, for example, using a traditionally typed User ID and password, can grant a user access to a QR code that they can scan or a registration code that they can input on a first device.

The association of a resource server with the User ID or Device ID of a first device grants subsequent direct access from the first device to the resource.

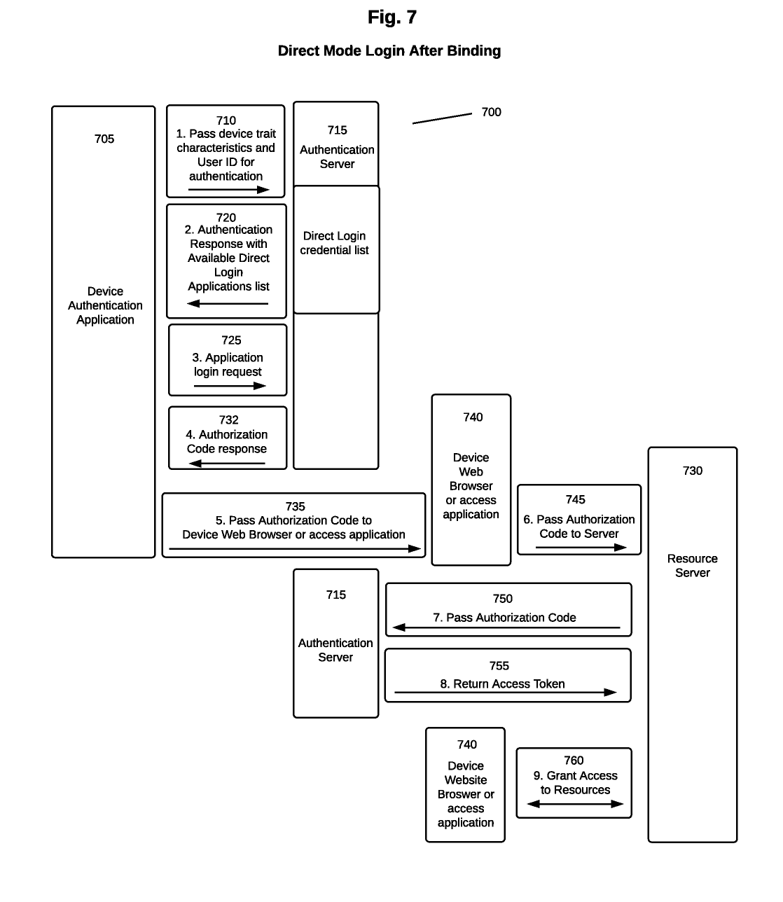

Thus, FIG. 2 schematically shows a direct mode authentication binding using access code system 200 where a user is using, in addition to an authenticated first device 235, a second device 210 that is not authenticated. FIG. 2 illustrates how an example authenticated first device 235 and a non-authenticated second device 210 may be used to gain access to a secure resource such as resource server 215. Access to a secure resource can be effected with an authentication application, such as a TRAITWARE™ application, on a first device being used to gain access to a website or another application's resources. By successfully authenticating a first device and by verifying preexisting authorization credentials to the website or application, the user can have direct access to those resources from within the TRAITWARE™ application on a first device. The preexisting authorization credentials are located on a TRAITWARE™ server, but can be located elsewhere. A TRAITWARE™ server is a server storing device information and user information and can compare that information against input information for the purpose of authenticating a device (i.e. the device requesting access is an authorized device). The methods illustrated by FIGS. 2, 5, and 6 are representative of the inventive process of creating the binding between a userID/deviceID and a resource. FIG. 7 then demonstrates the process of accessing that website/application.

In the system of FIG. 2, first device 235 is authenticated, preferably using the device trait characteristics, to determine if it has been registered such as with a TRAITWARE™ server. By authentication it is meant that the device currently communicating is the actual registered device. This can be accomplished by comparing the device trait characteristics against saved device trait characteristics. The authentication method for the first device is not limited to use of device trait characteristics, and can include other authentication methods known in the art.

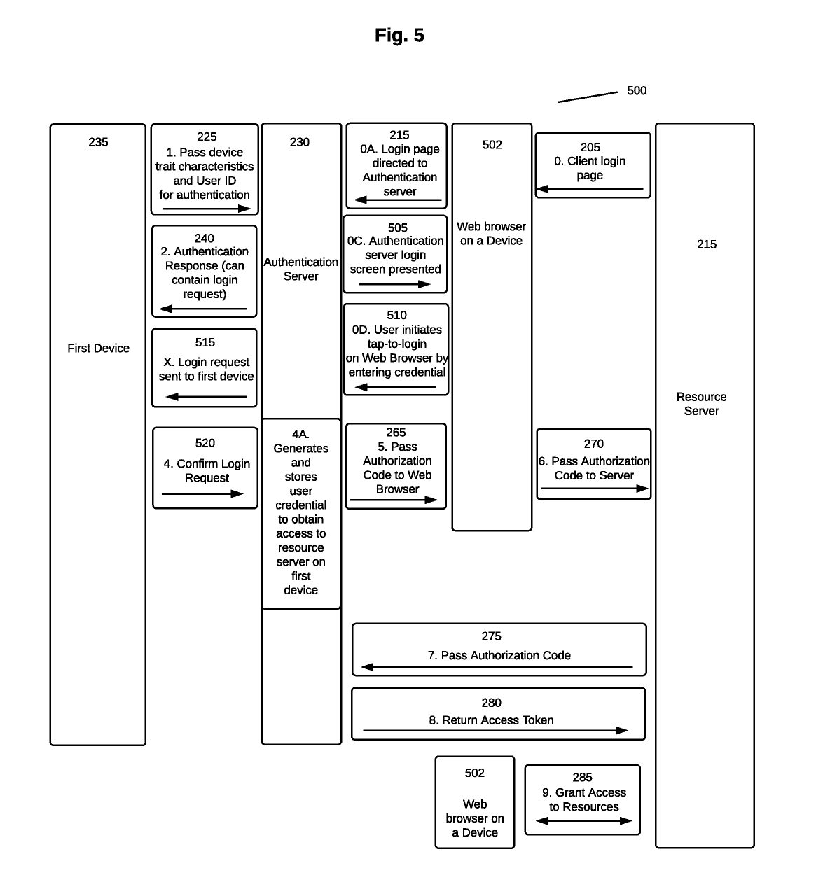

The processes can use OAuth 2.0, although it is not necessarily followed explicitly. Oauth 2.0 is an open standard for authorization. OAuth provides a method for clients to access server resources on behalf of a resource owner (such as a different client or an end-user). It also provides a process for end-users to authorize third-party access to their server resources without sharing their credentials (typically, a username and password pair), using user-agent redirections. (Muth integration with the TRAITWARE™ server, by a resource server, is generally performed prior to the processes described herein. The resource server having the secure resource registers with the authentication server and provides a redirect uniform resource identifier (“URI”) as well as receives a secret key and client identification from the authentication server. It is understood that these processes can be adapted to be used with other authentication and authorization protocols such as SAML, SCIM, OpenID Connect, WS-Trust, WS-Federation, and other authentication and authorization protocols known in the art. OAuth 2.0 and other commonly used protocols are useful in steps 0A, 0B, and 5-8 in the FIG. 5 system described below.

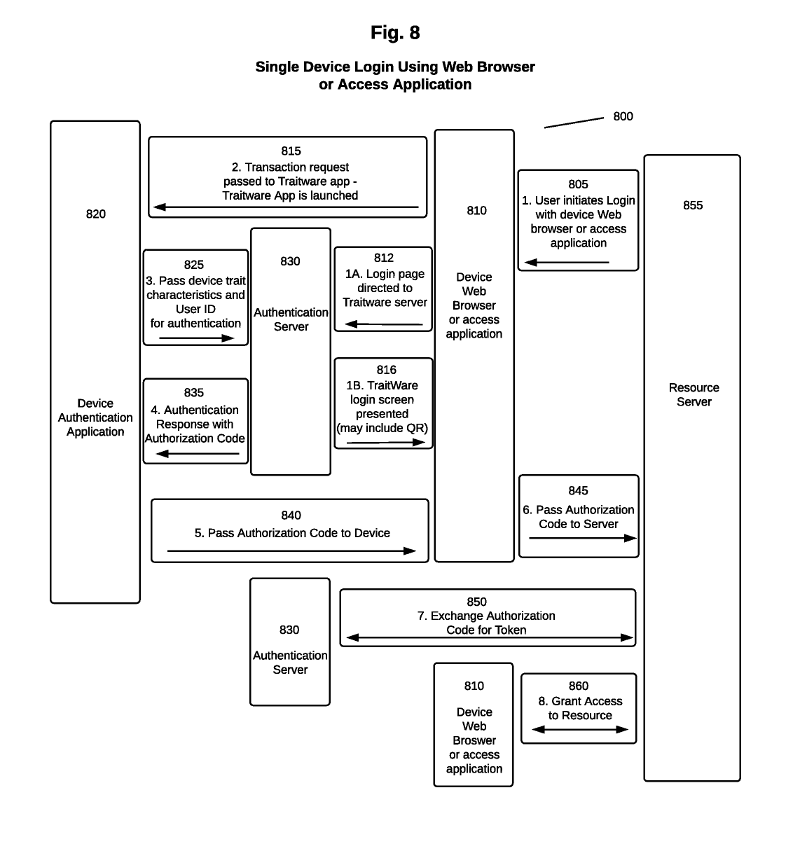

In general, the systems depicted in FIGS. 2, 5, 6, and 7 (as well as FIG. 8 (described below)) rely on using a resource server, also referred to as a client or third party server, to serve an initial web page to a browser. From this initial web page, a user can initiate a login such as by clicking a login button that invokes an application (single device mode) or by clicking a login button to take the user to the authentication server page where the user is presented with tap to login or QR methods of logging in. After the login button is selected from the client page, the client page is directed to an authentication server (tap to login or QR), which uses the OAuth 2.0 spec as reference for providing authorization codes and token exchanges. Single device mode login contacts the authentication server directly through an installed application.

The authorization server and the resource server can be the same server. They can also be completely distinct. Any mention of a TRAITWARE™ server is not limited to TRAITWARE™ authorization and can be effected with any authorization server running any authorization process available to the art and thus is generically referred to herein as an authorization server.

### Direct Mode Authorization System

The direct mode invention is a means to simplify multifactor authentication from a single device. In this method, credentials are created that can be used to create a list of secure resources that can be accessed by a registered user once they are authenticated on a device which can be verified as something they have and one or more additional factors are used for the authentication such as something they know, such as password or picture sequence (e.g. PHOTOAUTH™), or something they are, such as a biometric feature, which can include a fingerprint, voice print, iris scan, or vein record.

The user opens the user's authentication application such as the TRAITWARE™ application and they can then go to the direct mode, clicking a button that then presents a list of resource that were previously accessed, and for which the user is approved to access.

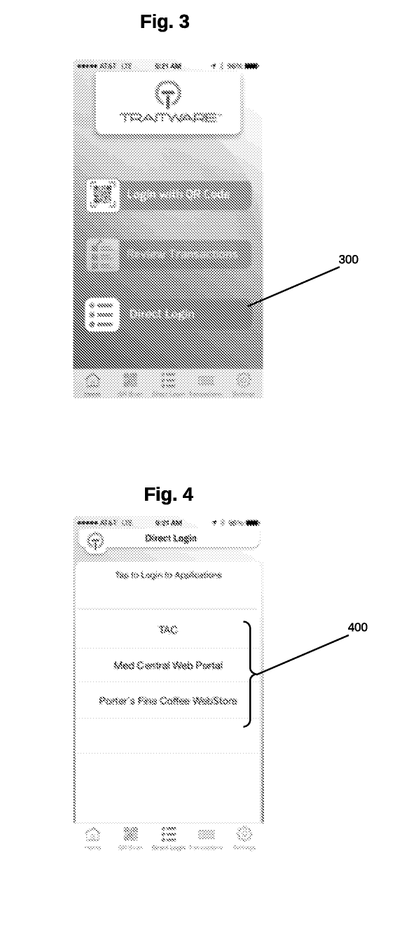

FIG. 3 shows an example embodiment screen shot of a direct mode access button 300 and FIG. 4 shows a sample list of resources 400, which in this case are secure websites. They could also be secure applications that need approval to access and use.

The credential for creating the lists are created the first time the user accesses the resource. Once the link is created the user can simply open their authentication app, click on the direct mode link, and the resource will open seamlessly on their device.

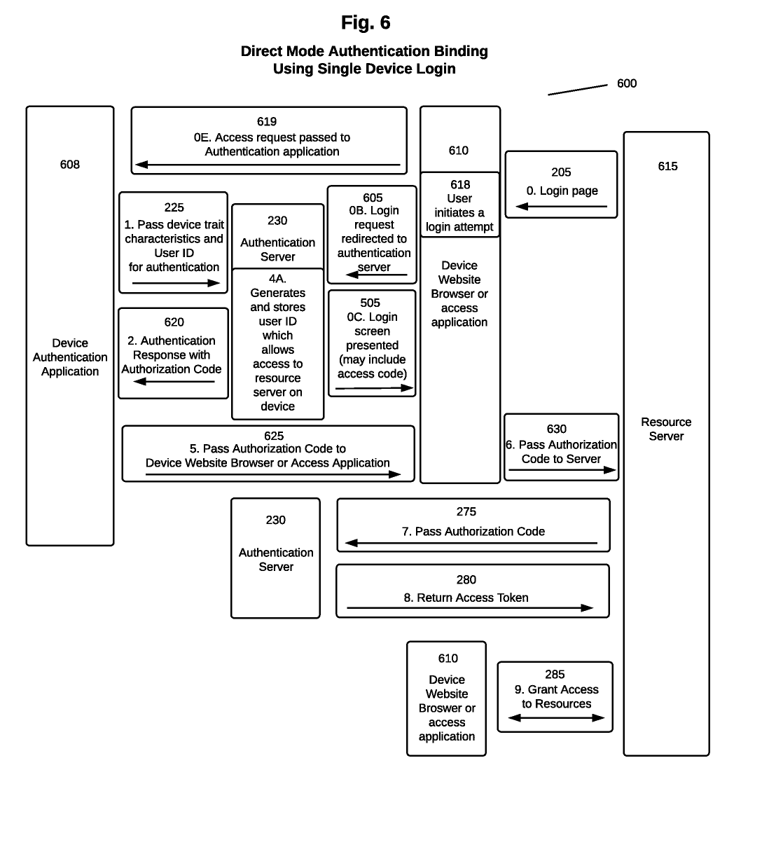

FIGS. 2 and 5 show the flows when the user accesses the resource on a second device using a first device as something they have to authenticate with. FIG. 6 shows the flow for accessing the resource from a first device something they have. FIG. 7 shows the flow for accessing the resource on the device that the user has registered as a device the user has from the authentication application on that device.

Thus, the features of the embodiment illustrated by FIG. 2 include a method for accessing a secure resource on a resource server, the method comprising the acts of: accessing a login page for the secure resource with a second device, the second device being a non-authenticated device, the login page providing an option to access an authentication server. Next, selecting the option to access the authentication server with the second device, then receiving on the second device an access code from the authentication server. Next, the access code is transferred to a first device, the first device being authenticated by the authentication server before or after receiving the access code. The first device access code is transferred to the authentication server for generation of an authorization code by the authentication server. Next, the authorization code is received on the second device for transfer to the resource server. Lastly, after the authorization code is received on the second device, the secure resource is accessed with the second device. Additionally, the inventive method describes a method for providing a user access to a secure resource on a resource server with a second device that is not authenticated, the method comprising the acts of: transmitting to the second device an access code from an authentication server. Next, authenticating a first device, and after authenticating the first device, receiving the access code on the authentication server from the first authenticated device. Lastly, an authorization code is generated on the authentication server and transmitted from the authentication server to the second device.

Optionally, the inventive method includes the additional acts of: receiving on the resource server the authorization code from the second device; and then providing access to the second device to the secure resource. As a further option, the authorization code may be transferred from the resource server to the authentication server with a token being generated on the authentication server, and optionally transferred to the resource server. The first device is authorized for access to the secure resource. Optionally further still, the resource server and authentication server are programmed to perform the acts specified in the inventive method.

### Direct Mode Authentication Binding Using Tap to Login

Turning now to FIG. 5, a conventional login page is used to obtain access rather than having an authenticated device receive an access code from a non-authenticated device. A user can be provided with a single login page that includes both a QR code and conventional login access so that the user can proceed with either the system of FIG. 2 or FIG. 5.

Turning now to FIG. 5, system of direct mode authentication binding using tap to login 500 features steps 0, 0A, 1, 2, 4, 4A, and 5-9 that are substantially the same as FIG. 2. The steps that are different will be described now.

There is no step in the system of FIG. 5 comparable to the acquiring access code step 3 in the system of FIG. 2. In FIG. 5, the web browser need not be a second device, which is generally a device that has not been registered for authentication, but can also be the first device that is authenticated in steps 1 and 2. That is why FIG. 5 refers to a web browser on a device 502 which can be the first device (a registered device) or device 2, a non-registered second device.

Step 0C—The authentication server 230 returns 505 a login page to the web browser on device 502. The login page contains a field to enter a credential. The credential can be the same as the user ID of step 1 or some other identification including a password, e-mail address, user name, or the like. It is possible to combine the systems by optionally providing a QR as an option to Device A, so the user can proceed as in FIG. 5 or as in FIG. 6 as described below.

Step 0D—The user initiates 510 tap-to-login on web browser by entering credential, the information required by the login screen, wherein authentication server 230 transmits 515 a login request (step X in FIG. 5) to first device 235 if such a login request is not part of step 2. First device 235, which was authenticated in steps 1 and 2, confirms 520 the login request to authentication server 230.

FIG. 5, describes a method for accessing a secure resource on a resource server, the method comprising the acts of: accessing a login page for the secure resource with a second device, the second device being a non-authenticated device, the login page providing an option to access an authentication server. Next, the second device is used to select the option to access the authentication server. Next, the second device receives a login page from the authentication server; a credential is entered to request login. The login request is confirmed with the first device—the first device having been authenticated to the authentication server for generating an authorization code by the authentication server. Next, the authorization code for transfer to the resource server is received on the second device, and after the code is received—the second device accesses the resource server.

The present invention discloses a method for accessing a secure resource on a resource server, including the steps of: accessing a login page for the secure resource with an authenticated device, the login page providing an option to access an authentication server. Next, the option to access the authentication server is selected. Next, the device receives a login page from the authentication server, and a credential is entered to request login. Confirming the login request with the first device, to the authentication server for generation of an authorization code by the authentication server. The device then receives the authorization code for transfer to the resource server, and after this receipt, the device accesses the secure resource.

A method for providing a user access to a secure resource on a resource server with a second device that is not authenticated, the method comprising the acts of transmitting to the second device an access code from an authentication server. A first device is then authenticated, and after this authentication, the authenticated server receives the access code from the first authenticated device. Next, the authentication server generates an authorization code, and the authentication server transmits the authorization code from the authentication server to the second device. This inventive method may optionally include the additional acts of: receiving on the resource server the authorization code from the second device, and providing access to the second device to the secure resource. The method may include the additional acts of transferring the authorization code from the resource server to the authentication server and generating a token on the authentication server. The method may additionally include the additional act of transferring the token to the resource server. In various embodiments, the first device is authorized to access the secure resource. In the inventive method, the resource server and authentication server may be programmed to perform all the acts specified.

### Direct Mode Authentication Binding System—Single Device Login

FIG. 6 shows single device login 600 where a user initiates a login into a website on a web browser of a first device with an authenticated device prior to login for access to a secure resource on a resource server. Upon authentication the user is logged into the website on the first device. The device has loaded on it: (i) an authentication application 605, and (ii) a browser and/or access application 610, access application 610 is tailored for access to secure resource server 615. The device browser and/or access application 610, is shown multiple times for illustrative purposes, however, browser/access application 610 is a single process.

Steps 1, and 6-9 are substantially the same as in FIG. 5, and thus only the other steps will be discussed in detail.

Step 0—To access a secure resource on the client server, the user has two choices. First, the user can use a browser on the user's device to access a login page that includes an option for access with an authenticated device, such as a TRAITWARE™ button option. Second, the user can open an access application that provides the same option. Thus a client website login page is displayed 205 on the web browser of the user's device or the access application 610 installed on the device is opened. Step 0B—The user initiates a login attempt 618. The user can initiate login attempt 618 on the web browser by clicking a login button, or the user initiates login attempt 618 from the access application. Login attempt 618 is automatically redirected 605 to authentication server 230.

Step 0B—Step 0C results in a login screen being presented 505 to the user with the option to authenticate using the authentication application previously installed on the first device. In step 0E, the user chooses to authenticate using the authentication application on the first device, the access request being passed 619 to the device authentication application 608 on the same device. The transaction request can include a session identifier and client id to the authentication application.

Step 2—The authentication server in response to the authentication request 225 responds 620 with an authorization code if the authentication is successful.

Step 5—The authorization code is passed 625 from the authentication application on the device to the access application or web browser on the device. At this point, if authentication is successful, the authentication server associates the User ID or Device ID from the device with the browser application that initially requested the login authentication via the website on the device web browser or the resource application on the device. This association acts as an authorization credential for subsequent login attempts (See FIG. 8). If the authentication request is denied an association is not made.

Step 6—The device website browser or second access application on the device 610 passes 630 the authorization code to resource server 615 using a redirect URI and authorization code with the state (session) identifier. “State” is a unique value used by the application to prevent cross-site request forgery (CSRF) attacks on the implementation. The value is typically a random unique string for a particular request, unguessable and kept secret.

From the user's standpoint, many of the steps are opaque. For applications, the user initiates a transaction request (Step 0B on FIG. 6, and Step 0A in FIGS. 2, 5, and 8), and the rest of the process is automatic, with the exception being that the user can be required to enter a credential in step 1. Alternatively, opening an application in step 0 may automatically trigger 0B and the rest of the process is automatic, the exception being that the user can be required to enter a credential in step 1.

The above processes and methods described by FIGS. 2, 5, and 6 can include passing some initial credentials to the resource server for authentication prior to authenticating the device via the authentication server. Initially authenticating with the resource server (also referred to as a client server), for example, using a traditionally typed User ID and password, can grant a user access to a QR code that they can scan or a registration code that they can input on the user's device. This initial authentication can include entering a PIN, a password, a PHOTOAUTH™ sequence, a biometric, a biometric hash, a biometric feature set, hardware profile or other authentication methods known in the art. The association of the resource server with the User ID or Device ID of the first device grants subsequent direct access from the user's device to the resource server. Alternatively, it can also allow the user to bypass traditional login screens of the resource server and use the methods and processes disclosed to authorize access to the resource server. Here a resource authorization credential is created on the resource server. The resource authorization credential can be stored on the resource server, the authentication server, or both. See FIG. 7 and corresponding description for an overview of the process.

Features of the FIG. 6, system include: a method to access a secure resource on a resource server comprising the acts of requesting access to the secure resource with a web site browser on a device and receiving a login page from an authentication server on the device. Next, using the login page, access to the secure resource is requested, and the request to access an authentication application on the device is transmitted. Next, using the device authentication application, authenticating the device with an authentication server. Next, receiving an authentication code on the device from the authentication server. Next, transmitting the authorization code to the resource server for transmission to the authentication server. Lastly, accessing the secure resource with the device browser. In one embodiment, the act of transmitting the access request to an authentication application on the device occurs automatically. In embodiments, the acts of using the device authentication application, receiving the authentication code, and transmitting the authorization code occur automatically.

In one embodiment of the present invention, the inventive method includes the steps of requesting access to a secure resource on a resource server comprising the acts of: requesting access to the secure resource with an access application on a device and receiving a login page from an authentication server on the device. Next, using the login page, requesting access to the secure resource and transmitting the access request to an authentication application on the device. Next, authenticating the device with the authentication server. Next, receiving an authentication code on the device from the authentication server. Next, transmitting the authorization code to the resource server for transmission to the authentication server. Lastly, accessing the secure resource with the device access application.

A method to access a secure resource on a resource server comprising the acts of: a) receiving on the resource server a request for access to the secure resource from a device and in response thereto transmitting a login page from an authentication server to the device; b) receiving from the device on the authentication server an authentication request and if the device is authenticated, in response thereto providing an authorization code; c) receiving from the device the authorization code on the resource server; d) granting to the device access to the secure resource. In some embodiments, steps (c)-(e) may occur automatically.

A system for performing the inventive method comprising the authentication server and resource server programmed for performing their respective acts.

In embodiments, the authentication application performs the acts of: a) transmitting device trait characteristics and a user id to an authentication server and receiving an authentication response and authentication code from the authentication server; and b) passing the authorization code to a web site browser or access application on the device.

It should be noted that the authentication application may perform the acts of (a) transmitting device trait characteristics and a user id to an authentication server and receiving an authentication response and authentication code from the authentication server; and (b) pass the authorization code to a web site browser or access application on the device.

Additionally, in response to the authentication request, if the device is authenticated, a user ID is generated and stored to allow access to the secure resource with the device.

### Direct Mode Login After Binding

A method of direct mode login after binding 700 is illustrated by FIG. 7. Once a user has authenticated a device, and if the user's User ID or Device ID has been given authorization credentials to a client or third party application (FIG. 2, 5, or 6), the user can quickly make login attempts from the device using the authentication application and web browser on the first device.

Step 1—The device authentication application 705 passes 710 a User ID and device trait characteristics to authentication server 715 for authentication. Step 2—If authentication is successful, a successful authentication response 720 is sent to device authentication application 705. The device is also provided with a list of available applications for direct login attempts for which the device has already been provided access using the systems shown in FIG. 2, 5, or 6. The user is allowed to use the functionality of the authentication application on the first device. Step 3—The user can access the direct login application list on the device. An application is selected from the list and the login request is passed 725 to authentication server 715. Step 4—Authentication server (715) returns 732 an authorization code response appended to a redirect URI for the resource. Step 5—Device authentication application 705 passes 735 a redirect URI and authorization code to device website browser 740. Step 6, the device website browser 740 uses the redirect URI and authorization code and passes 745 them to resource server 730. Step 7—Resource server 730 passes 750 authorization code to authentication server 715, and in Step 8 the authentication server 715 returns 755 an access token to resource server 730. In this way, the resource server exchanges the authorization code for a token. Step 9—Resource server 730 grants 760 access to secure resources to the device web browser 740.

The direct mode method can also be used to login to a second (or more) applications and is not exclusive to using a web browser on the device to login to a secure resource. In this method, the authorization code and redirect URI are passed to the second application. The second application passes the authorization code and redirect URI to the resource server. The client or third party server exchanges the authorization code for a token with the authentication server. The resource server then grants access to the secure resource to the second application on the device. The second application may require separate authentication in addition to the authentication of the first application. This could include entering a PIN, a password, a PHOTOAUTH™ sequence, a biometric, a TRAITWARE™ hardware profile, or other authentication method. A list of available applications/websites is populated within the application.

Features of the inventive system include: A method accessing a secure resource on a resource server comprising the acts of: a) authenticating a device by transmitting device trait characteristics and a user identification to an authentication server; b) receiving from the authentication server on the authenticated device a list of secure resources; c) using the authenticated device to request from the authentication server access to at least one of the secure resources; d) receiving on the authenticated device from the authentication server an authorization code; e) transmitting to the resource server hosting the requested secure resource the authorization code; and f) after step (e), accessing the requested secure resource. A method of providing to a device access to a secure resource on a resource server, the method comprising the acts of: a) receiving on an authentication server from the device, device trait characteristics and a user identification; b) determining if the device is a registered device and if it is, transmitting to the device a list of accessible secure resources and an authorization code; c) receiving on the resource server from the device the authorization code; and d) providing to the device access to the secure resource. A system for performing the method of the above method comprising the authentication server and the resource server programmed to perform the acts of feature 2.

### Single Device Login Using Web Browser or Access Application

Single device login is a process where a user initiates a login into a secure resource on a web browser of a device or an application on the device by authenticating the device prior to login. Upon authentication the user is logged into the secure resource. The single device mode simplifies the user experience when using multifactor authentication. The user has a device that is registered with an authentication service. When the user access a resource that is set up to use the authentication service the user can connect seamlessly to an authentication application as if it was part of the resource site.

With reference to FIG. 8, single device login using web browser or access application system 800 has the following steps and features: The user initiates 805 a login attempt on a device web browser or access application 810. This can be done, as illustrated in Step 1A, by clicking a login button on a web browser or access application directed 812 to a TRAITWARE™ authentication server 830. In Step 1B, TRAITWARE™ authentication server 830 automatically presents 816 a login screen, such as a TRAITWARE™ login page, to device web browser or access application 810.

The login page can contain an access code such as a QR code and a field to enter a credential.

Step 2—Tapping the login button passes 815 a session identifier (State) and client id to the device authentication application 820. Step 3—The device authentication application 820 passes 825 a user identification and hardware characteristics to the authentication server 830 for authentication. Step 4—If authentication is successful, the device authentication application 820 receives 835 a successful authentication response. Included in the response is an OAuth type authorization code appended to a redirect URI. Step 5—The redirect URI with the appended authorization code and state are passed 840 to device web browser or access application 810. Step 6—The first device web browser 810 passes 845 an authorization code or call to resource server 855 using the redirect URI and authorization code with the state identifier. Step 7—The resource server 855 exchanges 850 the authorization code for a token which is provided by authentication server 830. Step 8—Resource server 855 grants 860 access to the secure resource to the device web browser or access application 810.

The above processes and methods optionally can include passing some initial credentials to a resource server for authentication in Step 3 prior to authenticating the device via the authentication server. Initially authenticating with a resource server, for example using a traditionally typed User ID and password, can grant a user access to a QR code that the user can scan or a registration code that the user can input on the user's device. This initial authentication can include entering a PIN, a password, a PHOTOAUTH™ sequence, a biometric, a biometric hash, a biometric feature set, a device trait characteristics or other authentication methods known in the art. The access application can require separate authentication in addition to the authentication of the authentication application. This could include entering a PIN, a password, a PHOTOAUTH™ sequence, a biometric, a TRAITWARE™ trait signature, or other authentication methods known in the art.

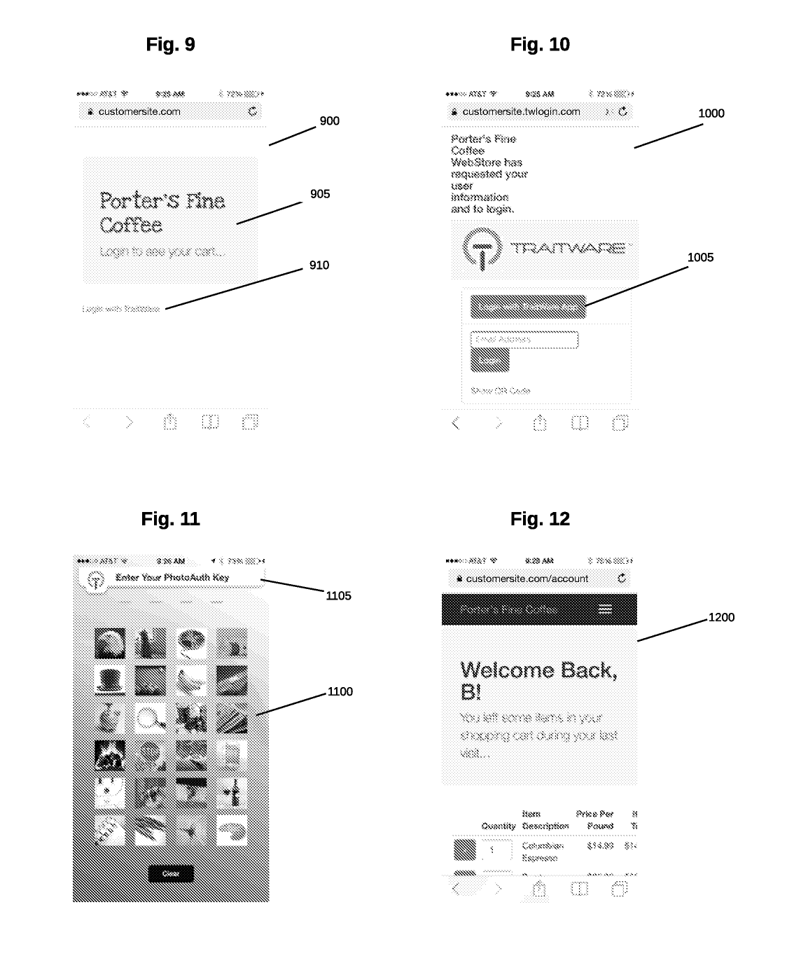

In FIG. 9, sample screen shot 900 provides an example of a version of the invention. First, the user opens a website 905 that is set up for second factor authentication. In this example the user clicks on “login with TRAITWARE™” link 910 that takes the user to the authentication server's site and present (as illustrated by FIG. 10) a new page 1000. The initial web server can also serve as the authentication site so everything can be done from the first page presented to the user. Stated another way, the user does not need to be redirected from a resource server to an authentication server because they are the same server.

In this example the authentication server is providing the connection to the authentication application via embedded code in the “Login with TRAITWARE™ App” button 1005. Clicking button 1005 launches the authentication application. When the user clicks button 1005, the authentication application is then opened to the authentication page illustrated by FIG. 11, which in this example is a PHOTOAUTH™ sign-in 1100 as shown in

The user is prompted 1105 to enter a PHOTOAUTH™ Key. When the user enters the user's PHOTOAUTH™ Key the authentication server verifies the correct key was entered and that the device is registered to a particular user and that the particular user has access rights to the resource that the user's trying to access. Once the authentication server has verified, the user checks that the digitally signed and sent packet of the device trait characteristics came from the user's registered device. The user is granted access to the resources and the secure resource application or website opens 1200 (FIG. 12) on the user's device when the user trait characteristics and user information are verified on the authentication server and when the digitally signed packet is verified with the users public key.

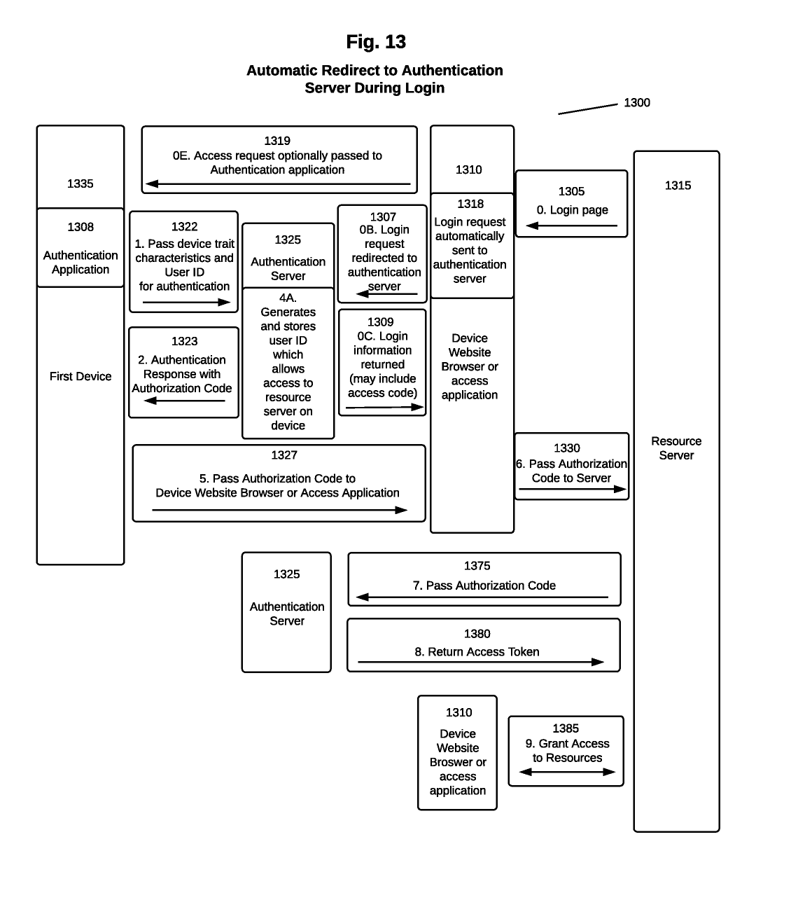

FIG. 13 shows an automatic login request redirected to the authentication server for a login attempt 1300 where a user first visits a website on a web browser or opens an access application on a device to login for access to a secure resource on a resource server. Upon authentication the user is logged into the website or access application. The first device 1335 has loaded on it: (i) an authentication application 1308, and (ii) a browser and/or access application 1310; access application 1310 is tailored for access to secure resource server 1315. The device browser and/or access application 1310, is shown multiple times for illustrative purposes, however, browser/access application 1310 is a single process. Alternatively, the website browser and the access application 1310 may be installed on a second device. In one embodiment, the login page 1305 may contain elements, such as a visual QR code, provided from information returned from the authentication server. These elements may be displayed side-by-side with traditional login elements like username and password fields.

Steps 1, and 6-9 are substantially the same as in FIG. 5, and thus the other steps will be discussed in detail now.

Step 0—client website login page is presented 1305 on the device web browser or access application 1310. (For an access application, the application installed on that device would be opened). Login request is automatically sent 1318 to block 1307. It should be noted that to access a secure resource on the client server, the user has two options. In a first option, the user can use a browser 1310 on a device to access a login page that automatically sends a login request 1318 to a specified login authentication server 1325, such as a TRAITWARE™ authentication server. In a second option, the user can open an access application 1310 that performs the same login request 1318. The end result of either first or second option: the login request through the login page presented 1305 is ultimately automatically redirected 1307 to authentication server 1325.

Step 0B—Step 0C results in a login screen being presented to the user with the option to authenticate using the authentication application previously installed on the first device. For example, a QR code may be displayed for scanning by the first device 1335. In one optional example where the website browser and/or application are installed on the first device, the access request is passed 1319 to the device authentication application 1308 on the same device. The transaction request can include a session identifier and client id to the authentication application.

The first device 1335 sends an authentication request 1322 to the authentication server 1325. If the authentication is successful the authentication server responds 1323 with an authorization code sent to first device 1335 (Step 2). At this point, the process determines if authentication is successful, the authentication server 1325 associates (Step 4A) the User ID or Device ID from the device with the browser application that initially requested the login authentication via the website on the device web browser or the resource or access application on the device. This association acts as an authorization credential for subsequent login attempts (See FIG. 8). If the authentication request is denied an association is not made. In one embodiment where the web application and/or the access application are installed on the first device 1335, the authorization code is passed 1327 from the authentication application 1308 on first device 1335 to the access application or web browser 1310 on the device (Step 5).

Step 6—Website browser or access application 1310 utilizes the redirect URI and an authorization code and passes 1330 them to the resource server 1315.

Steps 7 and 8—Authorization code is passed 1375 from resource server 1315 to authentication server 1325. Then, authentication server 1325 returns 1380 an access token to resource server 1315. In this way, resource server 1315 exchanges an authorization code for an access token. Access tokens are credentials used to access protected resources.

Finally, in Step 9—resource server 1315 grants 1385 device website browser or access application 1310 access to the secure resource.

In another embodiment where the web application and/or the access application are installed on a second device, FIG. 2. steps 3-9 cover the process, where optionally a QR code may be scanned.

In a further embodiment, the act of authentication on the first device may also happen automatically so as to produce a seamless login experience for the user.

The various processes disclosed within can be included in any combination in an authentication application installed on a first device. These processes may include: (i) the ability to scan a QR code to login to a website (FIG. 3), (ii) the ability to login to a website using a direct login button (FIG. 4), (iii) logging into a website or application on the same device that the authentication application is installed (FIG. 10), (iv) using tap-to-login where a notification for a login attempt is sent to an authentication application and the user has the ability to authenticate and allow the login attempt to proceed (FIG. 5), (v) the ability to request a code to add other devices to an existing authentication server user account (FIG. 1), and (vi) the ability to enter a code from an authenticated device into an authentication application on a second device, which on authentication adds that device to an account of the previously existing authentication server user account (FIG. 1).

Although the present invention has been described with reference to the preferred embodiments, it should be understood that various modifications and variations can be easily made by those skilled in the art without departing from the scope and spirit of the invention. Accordingly, the foregoing disclosure should be interpreted as illustrative only and is not to be interpreted in a limiting sense. It is further intended that any other embodiments of the present invention that result from any changes in application or method of use or operation, which are not specified within the detailed written description or illustrations contained herein yet, are considered apparent or obvious to one skilled in the art are within the scope of the present invention.

What is claimed is:

1. A method for a user having a first device to authorize a second device, the method comprising: accessing a first server with the first device; requesting with the first device authorization for the second device from the first server; receiving an authorization code from the first server on the first device; transmitting the authorization code from the first device to the second device; transmitting the authorization code to a second server with the second device the so that the second server can authenticate the second device; and
receiving a notice that the second device has been authenticated.

2. The method of claim 1, wherein the first and second servers are the same server.

3. The method of claim 1, wherein the first device is authorized.

4. The method of claim 1, the method further comprising: transmitting said first device trait characteristics from the first device to one of the servers; and transmitting said second device trait characteristics from the second device to one of the servers, wherein the first device and second device have a hardware profile, further comprising comparing of the hardware profiles of the first device and second device, wherein the second server can authenticate the second device if the comparison is within an allowed tolerance.

5. The method of claim 4, wherein the first device trait characteristics are salted with the user identification code and/or user information, and the second device trait characteristics are salted with the user identification code and/or user information.

6. The method of claim 5, wherein the first device or second device is salted with the user identification code in combination with the group consisting of: a password, PIN, user biometric information, or image code information.

7. A computer implemented system for authorizing a second device for a user having a first authorized device comprising: receiving a request from the first device for an authorization code for the second device; transmitting the authorization code to the first device; receiving the authorization code from the second device; authenticating the second device; and transmitting a notice that the second device has been authenticated.

8. The system according to claim 7, further comprising a computer or memory device having a program for performing: receiving a request, transmitting the authorization code, receiving the authorization code from the second device, authenticating the second device, and transmitting a notice.

9. A method for accessing a secure resource on a resource server, the method comprising: accessing a login page for the secure resource with a second device, the second device being a non-authenticated device, the login page providing an option to access an authentication server; selecting the option to access the authentication server with the second device; receiving on the second device an access code from the authentication server; transferring the access code to a first device, the first device being authenticated by the authentication server before or after receiving the access code; transferring the access code with the first device to the authentication server for generation of an authorization code by the authentication server; receiving on the second device the authorization code for transfer to the resource server; and after said authorization code is received on the second device, accessing the secure resource with the second device.

10. A method for providing a user access to a secure resource on a resource server with a second device that is not authenticated, the method comprising: transmitting to the second device an access code from an authentication server; authenticating a first device; after authenticating said first device, receiving the access code on the authentication server from the first authenticated device; generating on the authentication server an authorization code; transmitting the authorization code from the authentication server to the second device.

11. The method according to claim 10, the method further comprising: receiving on the resource server the authorization code from the second device; and providing access to the second device to the secure resource.

12. The method of claim 11, the method further comprising: transferring the authorization code from the resource server to the authentication server and generating a token on the authentication server.

13. The method of claim 12, the method further comprising transferring the token to the resource server.

14. The method of claim 11 or 13, wherein the first device is authorized for access to the secure resource.

15. A system for performing the method of any one of the features 11-13, wherein the resource server is programmed to perform all the acts specified; and the authentication server programmed to perform all the acts specified.

16. A method for accessing a secure resource on a resource server, the method comprising: accessing a login page for the secure resource with a second device, the second device being a non-authenticated device, the login page providing an option to access an authentication server; selecting the option to access the authentication server with the second device; receiving on the second device a login page from the authentication server and entering a credential to request login; confirming the login request with the first device, the first device having been authenticated, to the authentication server for generation of an authorization code by the authentication server; receiving on the second device the authorization code for transfer to the resource server; and after receiving on the second device the authorization code, accessing the secure resource with the second device.

17. A method for accessing a secure resource on a resource server, the method comprising: accessing a login page for the secure resource with an authenticated device, the login page providing an option to access an authentication server; selecting the option to access the authentication server; receiving on the device a login page from the authentication server and entering a credential to request login; confirming the login request with the device, to the authentication server for generation of an authorization code by the authentication server; receiving on the device the authorization code for transfer to the resource server; and after receiving on the device the authorization code, accessing the secure resource with the device.

18. A method of providing user access to a secure resource on a resource server with a second device that is not authenticated, the method comprising: transmitting to the second device an access code from an authentication server; authenticating a first device; after authenticating said first device, receiving the access code on the authentication server from the first authenticated device; generating on the authentication server an authorization code; and transmitting the authorization code from the authentication server to the second device.

19. The method of claim 18, the method further comprising: receiving on the resource server the authorization code from the second device; and providing the second device access to the secure resource.

20. The method of claim 19, the method further comprising: transferring the authorization code from the resource server to the authentication server and generating a token on the authentication server.

21. The method of claim 20, the method further comprising: transferring the token to the resource server.

22. The method of claim 18 or 21, wherein the first device is authorized for access to the secure resource.

23. A system for performing the method of any one of features 18-22, wherein the resource server is programmed to perform all the acts specified; and the authentication server is programmed to perform all the acts specified.

24. A method to access a secure resource on a resource server, the method comprising: a) requesting access to the secure resource with a web site browser on a device and receiving a login page from an authentication server on the device; b) using the login page, requesting access to the secure resource and transmitting the access request to an authentication application on the device; c) using the device authentication application, authenticating the device with an authentication server; d) receiving an authorization code on the device from the authentication server; e) transmitting the authorization code to the resource server for transmission to the authentication server;
and f) accessing the secure resource with the device browser.

25. The method of claim 24, wherein the act of transmitting the access request to an authentication application on the device occurs automatically.

26. The method of claim 24 or 25, wherein steps (c)-(e) occur automatically.

27. A method to access a secure resource on a resource server, the method comprising: (a) requesting access to the secure resource with an access application on a device and receiving a login page from an authentication server on the device; (b) using the login page, requesting access to the secure resource and transmitting the access request to an authentication application on the device; (c) authenticating the device with the authentication server; (d) receiving an authorization code on the device from the authentication server; (e) transmitting the authorization code to the resource server for transmission to the authentication server; and (f) accessing the secure resource with the device access application.

28. A method to provide access to a secure resource server, the method comprising: (a) receiving on the resource server a request for access to the secure resource from a device and in response thereto transmitting a login page from an authentication server to the device; (b) receiving from the device on the authentication server an authentication request and if the device is authenticated, in response thereto providing an authorization code; (c) receiving from the device the authorization code on the resource server; (d) granting to the device access to the secure resource.

29. The method of claim 28, wherein the authentication server and the resource server are programmed for performing their respective acts.

30. The method of claim 24 or 27, wherein the authentication application performs the acts of: (a) transmitting device trait characteristics and a user ID to an authentication server and receiving an authentication response and authorization code from the authentication server; and (b) passing the authorization code to a web site browser or access application on the device.

31. The method of claim 28 or 29, wherein the act of transmitting the access request to an authentication application on the device occurs automatically.

32. The method of claim 27, wherein steps (c)-(e) occur automatically.

33. The method of claim 28, wherein in response to the authentication request, if the device is authenticated, generating and storing a user ID to allow access to the secure resource with the device.

34. A method accessing a secure resource on a resource server, the method comprising: (a) authenticating a device by transmitting device trait characteristics and a user identification to an authentication server; (b) receiving from the authentication server on the authenticated device a list of secure resources; (c) using the authenticated device to request from the authentication server access to at least one of the secure resources; (d) receiving on the authenticated device from the authentication server an authorization code; (e) transmitting to the resource server hosting the requested secure resource the authorization code; and (f) after step (e), accessing the requested secure resource.

35. A method of providing to a device access to a secure resource on a resource server, the method comprising: (a) receiving on an authentication server from the device, device trait characteristics and a user identification; (b) determining if the device is a registered device and if it is, transmitting to the device a list of accessible secure resources and an authorization code; (c) receiving on the resource server from the device the authorization code; and (d) providing to the device access to the secure resource.

36. The method for performing the method of claim 35, wherein the authentication server and the resource server programmed to perform the acts of claim 35.

37. A method to provide access to a secure resource server, the method comprising: presenting a client website login page on a device web browser or access application; sending a login request from device web browser or access application to an authentication server, wherein said login request is sent automatically; redirecting the login request to the authentication server; sending from the device, an authentication request to the authentication server; determining if authentication is successful; associating, if authentication was successful, a User ID or a Device ID from said device with the browser application or the access application; passing authorization code from authentication application on the first device to the web browser or access application wherein the device has the web browser application or access application installed on the device; utilization of the redirect URI and authorization code by the device website browser or access application; passing redirect URI and authorization code to the resource server; passing authorization code from resource server to authentication server; returning an access token from authentication server to resource server, whereby said resource server exchanges an authorization code for an access token; granting, by the resource server, a device website browser or access application access to the secure resource.
